(19) United States
(12) Patent Application Publication
(10) Pub. No.: US 2026/0134517 A1
(43) Pub. Date: May 14, 2026

(54) METHOD FOR REMOVING NOISE FROM NOISY FIBSEM IMAGE

(71) Applicant: Yangtze University, Wuhan City (CN)

(72) Inventors: Xin Nie, Wuhan City (CN); Wen Xu, Wuhan City (CN); Ying Zhou, Wuhan City (CN); Chuanrui Sun, Wuhan City (CN); Yulong Hou, Wuhan City (CN)

(21) Appl. No.: 19/323,311

(22) Filed: Sep. 9, 2025

(30) Foreign Application Priority Data
Nov. 12, 2024 (CN) 202411607917 .8

(51) Int. Cl. G06T 5/60; G06T 5/70

(52) U.S. Cl. CPC G06T 5/60; G06T 5/70; G06T 2207/10061; G06T 2207/20081; G06T 2207/20084

(57) ABSTRACT

Provided is a method for removing noise from a noisy Focused Ion Beam Scanning Electron Microscope (FIBSEM) image, including constructing an initial Denoising Convolutional Neural Network (DnCNN) denoising model with a DnCNN model as a framework, optimizing model parameters to obtain an improved DnCNN denoising model, and denoising a noisy FIBSEM image using the improved DnCNN denoising model, where the method specifically includes the following steps: S1: constructing the initial DnCNN denoising model; S2: model parameter optimization through S2.1 data preprocessing, S2.2 residual learning training, and S2.3 model testing; S3: iteration; and S4: denoising. This application employs an improved DnCNN model combined with residual learning and batch normalization techniques, making the denoising process more stable and adaptable to different noise levels. Specifically for noise removal in FIBSEM images, this application effectively reduces noise and curtain effects caused by surface topography variations and compositional differences in samples.

### CROSS REFERENCE TO RELATED APPLICATION

This patent application claims the benefit and priority of Chinese Patent Application No. 202411607917.8, filed with the China National Intellectual Property Administration on Nov. 12, 2024, the disclosure of which is incorporated by reference herein in its entirety as part of the present application.

### TECHNICAL FIELD

The present disclosure relates to the technical field of image processing, and in particular, to a method for removing noise from a noisy Focused Ion Beam Scanning Electron Microscope (FIBSEM) image.

### BACKGROUND

Focused Ion Beam Scanning Electron Microscopy (FIBSEM) plays a crucial role in acquiring nanoscale images. However, during the scanning process, variations in surface topography and compositional differences of a sample can lead to inconsistent etching rates of the Focused Ion Beam (FIB) at different positions, resulting in noise and curtain effects in FIBSEM images, which significantly degrade image quality.

Currently, cutting-edge research on FIBSEM image denoising primarily focuses on the following approaches. Effective solutions typically include: using lower beam currents for fine section polishing, depositing a protective layer on the sample surface to flatten the surface, and employing rocking cutting techniques to achieve multi-angle ion beam processing. Reducing the ion beam current can effectively mitigate curtain effects caused by FIB processing; however, this method is time-consuming and cannot completely eliminate the effect. Depositing a protective layer on the sample surface not only effectively protects the surface but also partially overcomes curtain effects caused by surface irregularities (this method is commonly used in cross-section processing), yet it still fails to eliminate curtain effects arising from internal compositional differences in the sample. Additionally, while traditional image filtering operations can reduce noise to some extent, significant errors persist in subsequent threshold segmentation and volume fraction calculations, thereby affecting the accuracy of component classification results.

Therefore, there is an urgent need to develop more effective methods for denoising FIBSEM images to improve image quality and the accuracy of analytical results.

### SUMMARY

In view of the problems in the prior art, an objective of the present disclosure is to provide a method for removing noise from a noisy FIBSEM image.

The objective of the present disclosure can be achieved through the following technical solution: A method for removing noise from a noisy FIBSEM image, including constructing an initial Denoising Convolutional Neural Network (DnCNN) denoising model with a DnCNN model as a framework, optimizing model parameters to obtain an improved DnCNN denoising model, and denoising a noisy FIBSEM image using the improved DnCNN denoising model, where the method for removing noise from a noisy FIBSEM image specifically includes the following steps:
S1: constructing the initial DnCNN denoising model, where the initial DnCNN denoising model includes a noisy image loading and preprocessing unit, an input layer, a composite convolutional layer, and an output layer; the composite convolutional layer includes 1 head convolutional layer, 15 stability-enhanced convolutional layers, and 1 tail convolutional layer;
where parameters of the head convolutional layer are as follows: a convolutional kernel size of 3×3, a stride of 1, and a channel number of 64;
parameters of the tail convolutional layer are as follows: a convolutional kernel size of 3×3, a stride of 1, and a channel number of 64;
the stability-enhanced convolutional layer includes a convolutional operation unit, a batch normalization unit, and a rectified linear unit; a ReLU activation function is employed in the rectified linear unit; parameters of the convolutional operation unit are as follows: a convolutional kernel size of 3×3, a stride of 1, and a channel number of 64;
S2: model parameter optimization, including: S2.1 data preprocessing: artificially denoising noisy images acquired by a FIBSEM system to obtain a noise-free image set, and dividing the noise-free image set into a noise-free training set and a noise-free test set using a train_test_split function;
S2.2 residual learning training: subjecting original images from the noise-free training set to random cropping, geometric transformations, and noise addition to obtain an artificially noisy image training set, and training the initial DnCNN denoising model using images from the artificially noisy image training set and the original images from the noise-free training set as data pairs, to achieve parameter optimization, where during training, an L1 loss function is used to calculate errors, with a weight of the L1 loss function set to 1;
S2.3 model testing: adding predetermined noise to original images from the noise-free test set to form an artificial test sample set, and performing denoising using the trained initial DnCNN denoising model to obtain a denoised test image set; and
comparing images from the denoised test image set with the original images from the noise-free test set, and evaluating a denoising effect of the initial DnCNN denoising model using a peak signal-to-noise ratio as an evaluation metric;
S3: iteration: repeating step S2.2 and step S2.3 until the denoising effect meets an expected effect, thereby obtaining the improved DnCNN denoising model; and
S4: denoising: using the improved DnCNN denoising model to denoise a noisy target image acquired by the FIBSEM system, thereby obtaining a target image.

In the method for removing noise from a noisy FIBSEM image described above, in step S2.1, during division using the train_test_split function, parameter test_size=0.2 is set, designating 80% of data from the noise-free image set as data of the noise-free training set, and 20% of the data from the noise-free image set as data of the noise-free test set.

In the method for removing noise from a noisy FIBSEM image described above, the noisy image loading and preprocessing unit uses DataLoader to load data from a custom dataset and preprocesses the data by converting images from Height-Width-Channel (HWC) format to Channel-Height-Width (CHW) format, transforming the images into PyTorch tensors, and adjusting a channel format; and
parameters of the input layer are as follows: an input shape is (1300, 2000, 1), and the number of input channels is set to 1.

In the method for removing noise from a noisy FIBSEM image described above, in step S2.1, the geometric transformations specifically include flipping and rotating; and
during noise addition, noise at different levels is added according to characteristics of vertical striping in FIBSEM images, and a dataset size is expanded through an attention mechanism and image patching to ensure the initial DnCNN denoising model fully learns a feature relationship between noise and images during training.

In the method for removing noise from a noisy FIBSEM image described above, in step S2.2, during continuous training iterations, the initial DnCNN denoising model repeatedly receives training data, and performs forward propagation and backward propagation to update model parameters, training information is recorded periodically, and the initial DnCNN denoising model is saved periodically; to ensure reproducibility of a training process, a random seed is set such that same random results are obtained in each run.

In the method for removing noise from a noisy FIBSEM image described above, in step S2.1, the initial DnCNN denoising model is automatically saved every 5000 training steps, and current model parameters and optimizer state are saved.

In the method for removing noise from a noisy FIBSEM image described above, in step S4, a process of obtaining the target image is as follows: the noisy target image acquired by the FIBSEM system is processed by the noisy image loading and preprocessing unit and used as input data; the input data is fed through the input layer into the composite convolutional layer, where image features are extracted by the head convolutional layer and the stability-enhanced convolutional layers in the composite convolutional layer, and then the image features are reconstructed by the tail convolutional layer to generate a residual image of noise; the input image is subtracted by the residual image to obtain a denoised image; and finally, the denoised image is output through the output layer to yield the target image.

Compared with the prior art, the method for removing noise from a noisy FIBSEM image of the present disclosure has the following beneficial effects:

The present disclosure utilizes residual learning and batch normalization techniques to improve model training efficiency and denoising performance, significantly enhancing image quality. By artificially adding noise, the diversity of training data is increased, enabling the initial DnCNN denoising model to more comprehensively understand the relationship between noise and images during the learning process. This improves the generalization capability of the initial DnCNN denoising model, enhances the ability of the initial DnCNN denoising model to learn different noise characteristics, and ensures the accuracy of denoising results. Overall, the present disclosure adopts an improved DnCNN model combined with residual learning and batch normalization techniques, making the denoising process more stable and adaptable to different noise levels. Specifically for noise removal in FIBSEM images, the present disclosure effectively reduces noise and curtain effects caused by surface topography variations and compositional differences in samples, thereby improving image clarity and accuracy.

### BRIEF DESCRIPTION OF THE DRAWINGS

FIG. 1 is a development flowchart of a network model according to the present disclosure;

FIG. 2 is a structural diagram of an improved DnCNN model according to the present disclosure;

FIGS. 3A-3C show pixel value distributions of a noisy image, a clean image, and a residual image according to the present disclosure;

FIG. 4 shows a residual image restored using residual patches according to the present disclosure;

FIG. 5A shows an original image;

FIG. 5B shows a denoised image using a DnCNN;

FIG. 5C shows a threshold-segmented image of the original image; and

FIG. 5D shows a threshold-segmented image after DnCNN denoising.

### DETAILED DESCRIPTION OF THE EMBODIMENTS

The technical solutions of the present disclosure are described in further detail below with reference to the specific examples and accompanying drawings, but the present disclosure is not limited thereto.

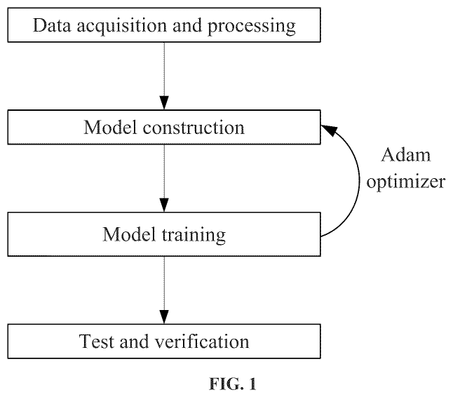

As shown in FIG. 1, a method for removing noise from a noisy FIBSEM image of the present disclosure includes constructing an initial DnCNN denoising model with a DnCNN model as a framework, optimizing model parameters to obtain an improved DnCNN denoising model, and denoising a noisy FIBSEM image using the improved DnCNN denoising model. The method for removing noise from a noisy FIBSEM image specifically includes the following steps:

S1: Construct the initial DnCNN denoising model, where the initial DnCNN denoising model includes a noisy image loading and preprocessing unit, an input layer, a composite convolutional layer, and an output layer; the composite convolutional layer includes 1 head convolutional layer, 15 stability-enhanced convolutional layers, and 1 tail convolutional layer.

Parameters of the head convolutional layer are as follows: a convolutional kernel size of 3×3, a stride of 1, and a channel number of 64.

Parameters of the tail convolutional layer are as follows: a convolutional kernel size of 3×3, a stride of 1, and a channel number of 64.

The stability-enhanced convolutional layer includes a convolutional operation unit, a batch normalization unit, and a rectified linear unit; a ReLU activation function is employed in the rectified linear unit; parameters of the convolutional operation unit are as follows: a convolutional kernel size of 3×3, a stride of 1, and a channel number of 64.

Batch normalization: Batch normalization is employed to stabilize the training process, prevent gradient explosion or vanishing, and ensure good stability during model training.

S2: Model parameter optimization, including the following sub-steps: S2.1: Data preprocessing: artificially denoising noisy images acquired by a FIBSEM system to obtain a noise-free image set, and dividing the noise-free image set into a noise-free training set and a noise-free test set using a train_test_split function.

S2.2 residual learning training: subjecting original images from the noise-free training set to random cropping, geometric transformations, and noise addition to obtain an artificially noisy image training set, and training the initial DnCNN denoising model using images from the artificially noisy image training set and the original images from the noise-free training set as data pairs, to achieve parameter optimization, where during training, an L1 loss function is used to calculate errors, with a weight of the L1 loss function set to 1.

Core concept of residual learning is as follows: By introducing skip connections, the network directly learns the residual between input and output rather than complex mapping relationships. In the DnCNN, the output is noise residual. The residual is subtracted from an input image to obtain a denoised image, enhancing denoising effectiveness and producing a clean image.

To improve the generalization capability of the initial DnCNN denoising model, original images undergo random cropping, geometric transformations, and noise addition to create the artificial noisy image training set.

S2.3: Model testing: adding predetermined noise to original images from the noise-free test set to form an artificial test sample set, and perform denoising using the trained initial DnCNN denoising model to obtain a denoised test image set; and
comparing images from the denoised test image set with the original images from the noise-free test set, and evaluating a denoising effect of the initial DnCNN denoising model using a peak signal-to-noise ratio as an evaluation metric.

S3: Iteration: repeating step S2.2 and step S2.3 until the denoising effect meets an expected effect, thereby obtaining the improved DnCNN denoising model.

S4: Denoising: using the improved DnCNN denoising model to denoise a noisy target image acquired by the FIBSEM system, thereby obtaining a target image.

In step S2.1, during division using the train_test_split function, parameter test_size=0.2 is set, designating 80% of data from the noise-free image set as data of the noise-free training set, and 20% of the data from the noise-free image set as data of the noise-free test set.

This parameter (test_size=0.2) of the function ensures 80% of the data is used for training while 20% of the data is used for testing. To ensure fair evaluation of model performance, the test dataset is not involved in model training. This division approach ensures that most of the data are grouped into the training dataset, enabling the initial DnCNN denoising model to learn more features, while the test set evaluates the generalization capability of the initial DnCNN denoising model.

The noisy image loading and preprocessing unit uses DataLoader to load data from a custom dataset and preprocesses the data by converting images from HWC format to CHW format, transforming the images into PyTorch tensors, and adjusting a channel format.

Parameters of the input layer are as follows: an input shape is (1300, 2000, 1), and the number of input channels is set to 1.

In step S2.1, the geometric transformations specifically include flipping and rotating.

During noise addition, noise at different levels is added according to characteristics of vertical striping in FIBSEM images, and a dataset size is expanded through an attention mechanism and image patching to ensure the initial DnCNN denoising model fully learns a feature relationship between noise and images during training.

In step S2.2, during continuous training iterations, the initial DnCNN denoising model repeatedly receives training data, and performs forward propagation and backward propagation to update model parameters, training information is recorded periodically, and the initial DnCNN denoising model is saved periodically; to ensure reproducibility of a training process, a random seed is set such that same random results are obtained in each run.

In step S2.1, the initial DnCNN denoising model is automatically saved every 5000 training steps, and current model parameters and optimizer state are saved.

In step S4, a process of obtaining the target image is as follows: the noisy target image acquired by the FIBSEM system is processed by the noisy image loading and preprocessing unit and used as input data; the input data is fed through the input layer into the composite convolutional layer, where image features are extracted by the head convolutional layer and the stability-enhanced convolutional layers in the composite convolutional layer, and then the image features are reconstructed by the tail convolutional layer to generate a residual image of noise; the input image is subtracted by the residual image to obtain a denoised image; and finally, the denoised image is output through the output layer to yield the target image.

The following practical operation can be taken as an example:

This embodiment aims to describe the detailed process of using the improved DnCNN for FIBSEM image denoising. FIG. 1 illustrates the development workflow of the network model.

1. Data collection and preprocessing: Original images are acquired under a FIBSEM imaging system, with an image format of HWC and a size of 2000×1300. During data loading, noisy images are converted into PyTorch tensors and adjusted to CHW format. Subsequently, the images are divided into multiple 40×40 small image patches, and noise is added.

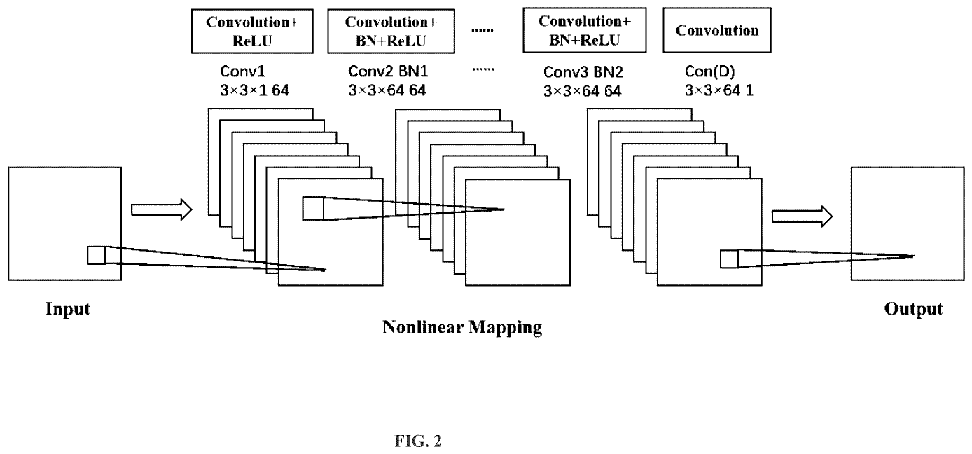

2. Model workflow: FIG. 2 is a structural diagram of an improved DnCNN model. A noisy target image acquired by the FIBSEM system is processed by the noisy image loading and preprocessing unit and used as input data. The input data is fed through the input layer into the composite convolutional layer, where image features are extracted by the head convolutional layer and the stability-enhanced convolutional layers in the composite convolutional layer. The image features are then reconstructed by the tail convolutional layer to generate a residual image of noise. The residual image represents noise features learned by the network and reflects noise patterns identified by the network. A denoised image is obtained by subtracting the residual image from the input image and is finally output through the output layer to yield a target image.

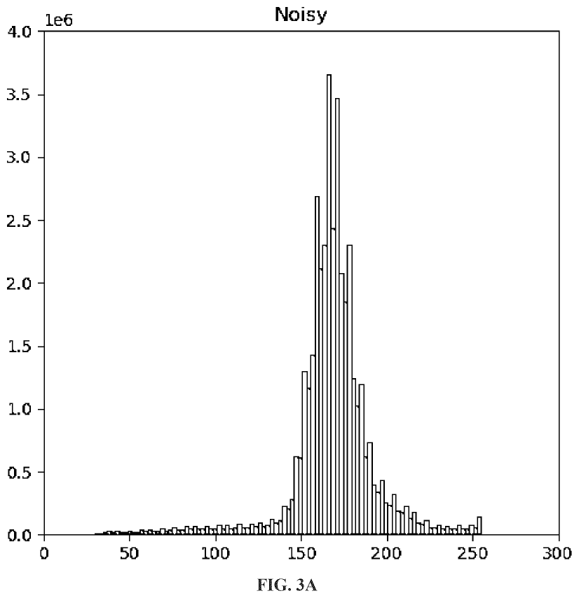

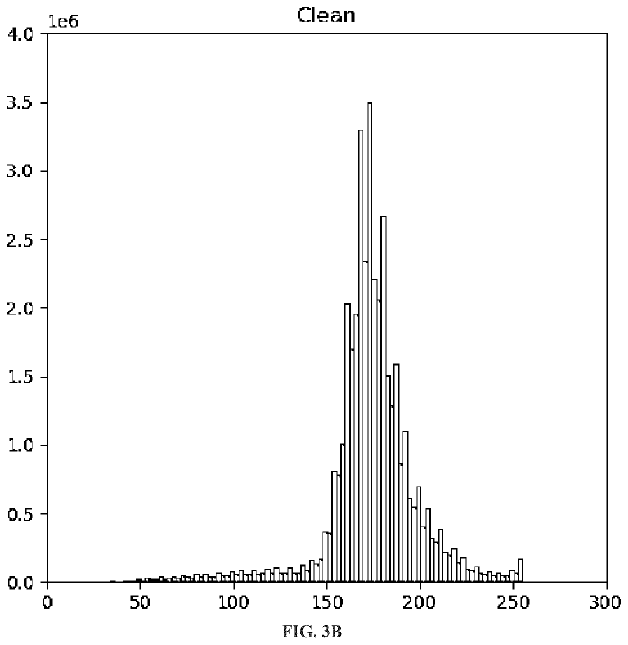

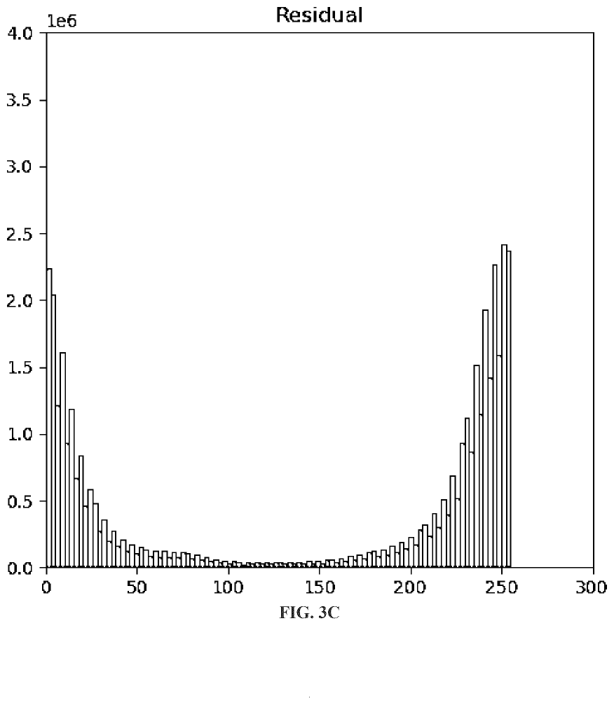

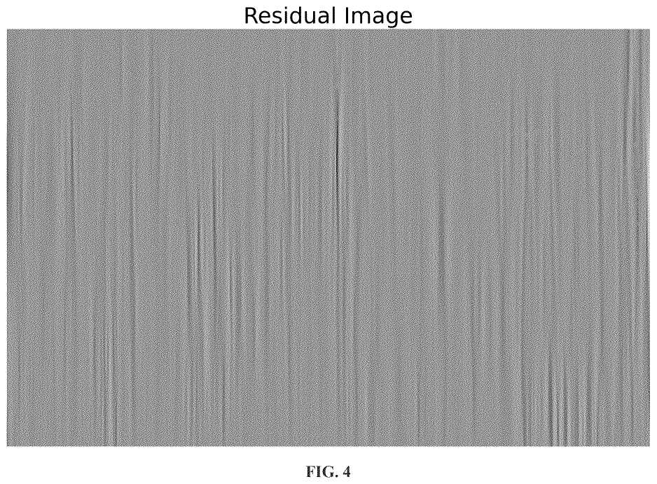

During the denoising process of the improved DnCNN, FIGS. 3A-3C display pixel value distributions of a noisy image, a clean image, and a residual image, and FIG. 4 shows a residual image restored using residual patches, aiding in understanding the concept of residual learning and the process of generating residual images, thereby allowing observation of the noise distribution features learned by the network. The “noisy image” minus the “residual image” yields the “denoised image,” i.e., the denoised image completed through residual learning.

3. Result analysis and application: The “denoised image” is used for subsequent analysis and characterization of pore features. First, the differences between the original image and the denoised image are analyzed using two metrics: peak signal-to-noise ratio (PSNR) and structural similarity index measure (SSIM). The calculated PSNR is 32 dB, indicating a small error between the denoised image and the original clean image, reflecting high image quality. The SSIM of 0.77 indicates that the denoised image has good similarity to the original image in terms of structure, brightness, and contrast, demonstrating the effectiveness of the network in preserving structural information.

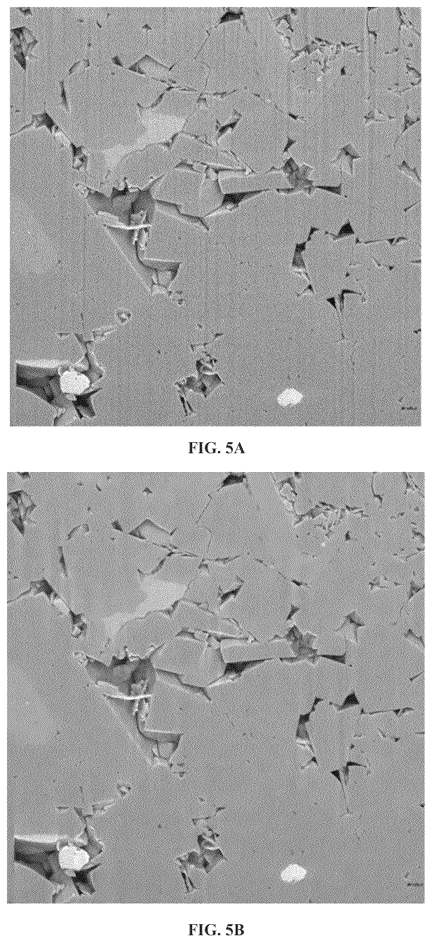

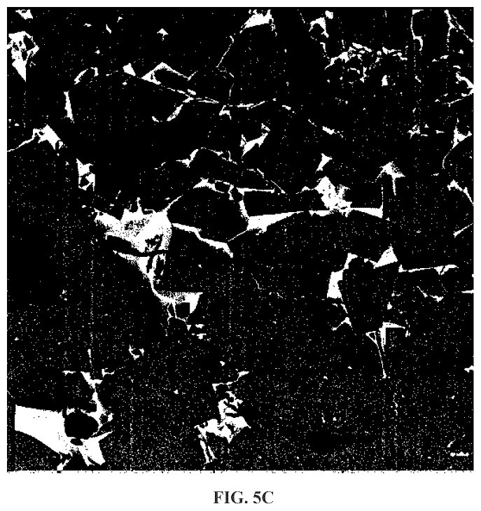

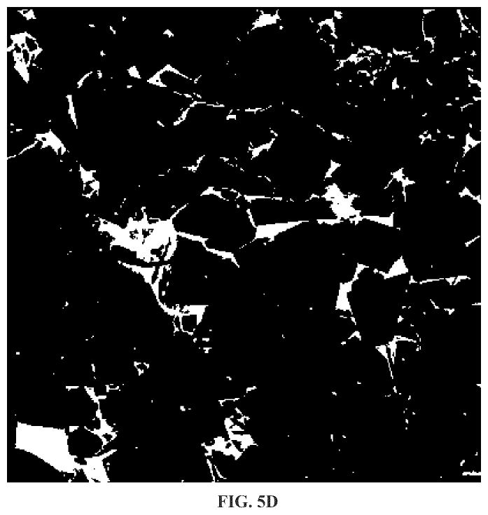

Secondly, the image denoising effect is evaluated in terms of porosity. FIG. 5A and FIG. 5B show an original image and a denoised image using the improved DnCNN, respectively, while FIG. 5C and FIG. 5D show a threshold-segmented image of the original image and a threshold-segmented denoised using the improved DnCNN, respectively. The manually calculated porosity is 6.1%, which is used as true data for reference. After noise removal through the denoising process, the porosity of the “denoised image” is 6.3%, whereas the porosity of the original image is 7.9%. In comparison, the porosity of the image denoised by the improved DnCNN model is closer to the true data, more clearly revealing the pore structure and facilitating further pore connectivity analysis and feature extraction.

The specific embodiments described herein are merely intended to illustrate the spirit of the present disclosure by way of example. A person skilled in the art can make various modifications or supplements to the specific embodiments described or replace them in a similar manner, but it may not depart from the spirit of the present disclosure or the scope defined by the appended claims. Although the present disclosure has been described in detail and illustrated in the drawings and the foregoing description, such description and illustration are to be considered illustrative or exemplary and not restrictive. It is understood that changes and modifications may be made by those of ordinary skill in the art without departing from the scope of the appended claims. Specifically, the present disclosure covers additional implementations with any combination of features from the aforementioned different implementations. Where the expressions “generally” or “substantially” are used, this patent application shall be considered as disclosing that these features and values are equally fully satisfied, i.e., without the aforementioned characterizations of “generally” or “substantially.”

What is claimed is:

1. A method for removing noise from a noisy Focused Ion Beam Scanning Electron Microscope (FIBSEM) image, comprising constructing an initial Denoising Convolutional Neural Network (DnCNN) denoising model with a DnCNN model as a framework, optimizing model parameters to obtain an improved DnCNN denoising model, and denoising a noisy FIBSEM image using the improved DnCNN denoising model, wherein the method for removing noise from the noisy FIBSEM image specifically comprises the following steps:
S1: constructing the initial DnCNN denoising model, wherein the initial DnCNN denoising model comprises a noisy image loading and preprocessing unit, an input layer, a composite convolutional layer, and an output layer; the composite convolutional layer comprises 1 head convolutional layer, 15 stability-enhanced convolutional layers, and 1 tail convolutional layer;
wherein parameters of the head convolutional layer are as follows: a convolutional kernel size of 3×3, a stride of 1, and a channel number of 64;
parameters of the tail convolutional layer are as follows: a convolutional kernel size of 3×3, a stride of 1, and a channel number of 64;
the stability-enhanced convolutional layer comprises a convolutional operation unit, a batch normalization unit, and a rectified linear unit; a ReLU activation function is employed in the rectified linear unit; parameters of the convolutional operation unit are as follows: a convolutional kernel size of 3×3, a stride of 1, and a channel number of 64;
S2: model parameter optimization, comprising: S2.1 data preprocessing: artificially denoising noisy images acquired by a FIBSEM system to obtain a noise-free image set, and dividing the noise-free image set into a noise-free training set and a noise-free test set using a train_test_split function;
S2.2 residual learning training: subjecting original images from the noise-free training set to random cropping, geometric transformations, and noise addition to obtain an artificially noisy image training set, and training the initial DnCNN denoising model using images from the artificially noisy image training set and the original images from the noise-free training set as data pairs, to achieve parameter optimization, wherein during the training, an L1 loss function is used to calculate errors, with a weight of the L1 loss function set to 1;
S2.3 model testing: adding predetermined noise to original images from the noise-free test set to form an artificial test sample set, and performing denoising using the trained initial DnCNN denoising model to obtain a denoised test image set; and
comparing images from the denoised test image set with the original images from the noise-free test set, and evaluating a denoising effect of the initial DnCNN denoising model using a peak signal-to-noise ratio as an evaluation metric;
S3: iteration: repeating step S2.2 and step S2.3 until the denoising effect meets an expected effect, thereby obtaining the improved DnCNN denoising model; and
S4: denoising: using the improved DnCNN denoising model to denoise a noisy target image acquired by the FIBSEM system, thereby obtaining a target image.

2. The method for removing noise from the noisy FIBSEM image according to claim 1, wherein in step S2.1, during division using the train_test_split function, parameter test_size=0.2 is set, designating 80% of data from the noise-free image set as data of the noise-free training set and 20% of the data from the noise-free image set as data of the noise-free test set.

3. The method for removing noise from the noisy FIBSEM image according to claim 1, wherein the noisy image loading and preprocessing unit uses DataLoader to load data from a custom dataset and preprocesses the data by converting images from Height-Width-Channel (HWC) format to Channel-Height-Width (CHW) format, transforming the images into PyTorch tensors, and adjusting a channel format; and
parameters of the input layer are as follows: an input shape is (1300, 2000, 1), and the number of input channels is set to 1.

4. The method for removing noise from the noisy FIBSEM image according to claim 1, wherein in step S2.1, the geometric transformations specifically comprise flipping and rotating; and
during noise addition, noise at different levels is added according to characteristics of vertical striping in FIBSEM images, and a dataset size is expanded through an attention mechanism and image patching to ensure that the initial DnCNN denoising model fully learns a feature relationship between noise and images during training.

5. The method for removing noise from the noisy FIBSEM image according to claim 1, wherein in step S2.2, during continuous training iterations, the initial DnCNN denoising model repeatedly receives training data, and performs forward propagation and backward propagation to update model parameters, training information is recorded periodically, and the initial DnCNN denoising model is saved periodically; to ensure reproducibility of a training process, a random seed is set such that same random results are obtained in each run.

6. The method for removing noise from the noisy FIBSEM image according to claim 1, wherein in step S2.1, the initial DnCNN denoising model is automatically saved every 5000 training steps, and current model parameters and optimizer state are saved.

7. The method for removing noise from the noisy FIBSEM image according to claim 1, wherein in step S4, a process of obtaining the target image is as follows: the noisy target image acquired by the FIBSEM system is processed by the noisy image loading and preprocessing unit and used as input data; the input data is fed through the input layer into the composite convolutional layer, wherein image features are extracted by the head convolutional layer and the stability-enhanced convolutional layers in the composite convolutional layer, and then the image features are reconstructed by the tail convolutional layer to generate a residual image of noise; the input image is subtracted by the residual image to obtain a denoised image; and finally, the denoised image is output through the output layer to yield the target image.
